(19) United States
(12) Patent Application Publication
(10) Pub. No.: US 2014/0120235 A1
(43) Pub. Date: May 1, 2014

(54) ROBOTIC VENDING MACHINE

(71) Applicant: Robofusion, Inc., Charleston, SC (US)

(72) Inventors: Allan S. Jones, Awendaw, SC (US); James S. Wolf, Silver Lake, OH (US); Jeffrey L. Redington, Nooksack, WA (US); Todd A. Smith, Springboro, OH (US); Ward Beckwith, Charleston, SC (US); David E. Brain, Keene, TX (US); Eric F. Marcil, Springboro, OH (US)

(21) Appl. No.: 14/062,134

(22) Filed: Oct. 24, 2013

Related U.S. Application Data
(60) Provisional application No. 61/718,745, filed on Oct. 26, 2012.

(51) Int. Cl. A23G 9/28

(52) U.S. Cl. CPC A23G 9/28; Y10S 901/30
USPC 426/565; 426/416; 99/494; 901/30

(57) ABSTRACT

A system and method for preparing treats is presented. A vending machine for building custom ordered treats includes an enclosed housing with windows. A robot is inside the housing and first and second user interfaces are attached to the housing. The first and second user interfaces accept inputs from first and second users respectively. The robot has left and right arms as well as a simulated head to make it appear somewhat human like. The left and right arms work together to assemble a single treat when only one treat has been requested at the vending machine. However, when two different treats have been requested the left arm can work independently, at least sometimes, of the right arm on a custom treat for the first user. Similarly, the right arm can, at least sometimes, work independently of the left arm on a custom treat for the second user.

### CROSS REFERENCE TO RELATED APPLICATION

This application claims priority from U.S. Provisional Application Ser. No. 61/718,745 filed Oct. 26, 2012; the disclosure of which is incorporated herein by reference.

### BACKGROUND

1. Technical Field

The present invention relates in general to automated dispensing/vending machines. More particularly, the apparatus, systems and methods relate to a vending machine for dispensing edible items such as candies and/or ice cream that are first dispensed into a cup or other container before being provided to a consumer. Specifically, the apparatus, systems and methods provide for dispensing edible items using a robot with two arms.

2. Background of the Invention

Automated machines for dispensing ice cream and other frozen treats are known in the art. For example, Chirnomas (U.S. Pat. No. 5,027,698) discloses an ice cream vending machine wherein the machine dispenses pre-filled containers of ice cream. Davis et al. (U.S. Patent Application Publication No. 2004/0251270) describes an ice cream dispensing machine for dispensing soft-serve ice cream. Kateman et al. (U.S. Pat. No. 7,052,728) describes a machine for vending single servings of different flavors wherein selected flavorants are mixed into a base liquid prior to freezing. These and other automated vending devices do not provide the customer an enhanced purchase occasion in that the process of preparing and conveying the selected product is generally invisible to the customer. Alcaraz et al. (U.S. Pat. No. 4,889,210) describes a robotic vending machine. However, in the Alcaraz patent, the dispensing process is limited to transferring pre-packaged items to the customer or to placing single items (such as a beverage) into a container. Therefore, a better way of dispensing edible items is needed.

### SUMMARY

The preferred embodiment of the invention includes a vending machine for building custom ordered treats. The vending machine includes an enclosed housing, a robot, and first and second user interfaces. The enclosed housing has windows for viewing custom treats as they are created. The first and second user interfaces accepts input from first and second users respectively. The robot has left and right arms as well as a simulated head to make it appear somewhat human like. The left and right arms may work together to assemble a single treat when only one treat has been requested at the vending machine. However, when two different treats have been requested, the left arm may work independently, at least sometimes, of the right arm to assemble a custom built treat for the first user. Similarly, the right arm can, at least sometimes, work independently of the left arm to assemble a custom built treat for the second user.

Some configurations of the preferred embodiment can include a chilled product dispenser. The chilled product dispenser dispenses a chilled product such as ice cream, frozen yogurt or the like. For example, the chilled product dispenser can dispense a product downward and the robot can hold a cup below the dispenser to receive the product into the cup. The chilled product dispenser is accessible by both the right arm and left arm of the robot.

In some configurations, the housing has a top (e.g., ceiling), a bottom, a front side, a back side, a left side and a right side. At least three sides of the housing have windows so that users can easily view their treat being created. Rows of topping dispensers are located along the left and right sides of the housing. Each topping dispenser could dispense candy, sprinkles, nuts, granola, or the like. Each topping dispenser has a topping container that is removably attached to a ceiling mount hub that is attached to the top of the housing. A window on each side of the housing can act as a hinged door that can be unlocked to provide easy access to the topping dispensers so that their topping containers can easily be removed from their ceiling mount hubs and refilled. Valve housings are attached to the bottom ends of the topping containers. In operation, a computer controls a motor in the ceiling mount hubs that turns a shaft that turns a topping disk in the valve housing which causes a controlled amount of a topping to enter a delivery tube. Gravity sends that topping downward and out from an opening at the bottom of the delivery tub and into a cup held under the tub by the robot.

Another configuration of the preferred embodiment is a method of building multi-layered edible treats at a kiosk. The method begins by receiving payments at the kiosk from a first user and a second user that are requesting edible treats. The method uses a left arm of a robot that has left and a right arms to maneuver a first holder (e.g., cup) for the first users treat to a location to receive a first edible portion of that treat. The first edible portion of the first user's treat is then dispensed into the first holder. Similar to the left arm, the method uses the right arm to maneuver a second holder for an edible treat for a second user to a location to receive a first edible portion of the second user's treat. After that, the method dispenses the first edible potion of the second user's edible treat into the second holder.

The method can continue adding toppings with each robot arm working on an individual treat. For example, the method can use the left arm of the robot to maneuver the first holder of the first user's treat to a location to receive a second edible portion of the first users treat. The location to receive the first edible portion is different than the location to receive the second edible portion. The method dispenses the second edible portion at that location on top of the first portion within the cup. For example, the first edible portion can be a frozen confectionery such as ice cream or yogurt and the second edible portion of the edible treat for the first user can be a candy. The right arm can similarly in parallel with the left arm add a second portion to the second user's edible treat.

The method can continue building the edible treat for the first user using the robot. After it is completed, the robot can deliver the completed edible treat to a pick-up location at the kiosk. When it is at that location, the robot can open a door at that location to give the first user access to their treat. Now that the robot only needs to complete the second treat, the robot can complete the edible treat for the second user using the left arm together with the right arm. In some circumstances it is conceivable that the robot can pass the second holder of the second treat a gripper (e.g., hand) at the end of the right arm to another gripper at the end of the left arm while preparing a treat if there is an ingredient that only the right arm may reach.

### BRIEF DESCRIPTION OF THE DRAWINGS

Preferred embodiments of the invention will now be described in further detail. Other features, aspects, and advantages of the present invention will become better understood with regard to the following detailed description, appended claims, and accompanying drawings where:

FIG. 1 is a front view of a preferred embodiment of a system for providing a treat.

FIG. 2 is a side view of the preferred embodiment of a system for providing a treat.

FIG. 3 is a front view of a robot of the system providing a treat.

FIG. 4 is a perspective view of a product delivery assembly of the system providing a treat.

FIG. 5 is an exploded view of the product delivery assembly of the system providing a treat.

FIG. 6 is a perspective view of a topping dispenser of the system providing a treat.

FIG. 6A is a view of a portion of an assembly internal view of the topping dispenser.

FIG. 7 is an exploded view of the topping dispenser of the system providing a treat.

FIG. 8 is a top view of the preferred embodiment of a system for providing a treat illustrating the robot preparing two separate treats using both arms.

FIG. 9 is a system schematic illustrating the major components of the preferred embodiment of a system for providing treats using a robot with two arms.

FIG. 10 is a flow chart showing the assembly of a treat by the preferred embodiment of the system for providing a treat.

FIG. 11 is an exemplary first screen display welcoming the user to the system for providing a treat

FIG. 12 is an exemplary second screen display inviting the user to personally select an animated robotic character to usher them through the assembly process.

FIG. 13 is an exemplary third screen display inviting the user to personally select the ingredients for incorporation into their treat and to select the order those ingredients are assembled.

FIG. 14 is an exemplary fourth screen display showing an animation of the assembly of the treat.

FIG. 15 is an exemplary fifth screen display showing an animation of the delivery of the assembled treat.

Similar reference numbers in different drawings refer to the same element.

### DETAILED DESCRIPTION OF THE PREFERRED EMBODIMENTS

The apparatus, systems and methods described in the Figures below utilize a two armed robot in a vending type of machine. The two armed robot is programmed to operate in a variety of ways to simulate one of several different personalities. The personality can be selected at the time a consumer makes a request at the machine. Also, the two armed robot can service two customers at the same time or use both arms while serving a single customer.

The description below often discusses the two armed robot building a “treat” for a user/customer, however, it could build a variety of other products in a vending type of environment. For example, it could be used to serve alcoholic beverages and could combine two or more components when preparing a variety of alcoholic beverages. For example two or more liquids can be added together when creating mixed drinks or two or more layers may be added when creating other alcoholic beverages.

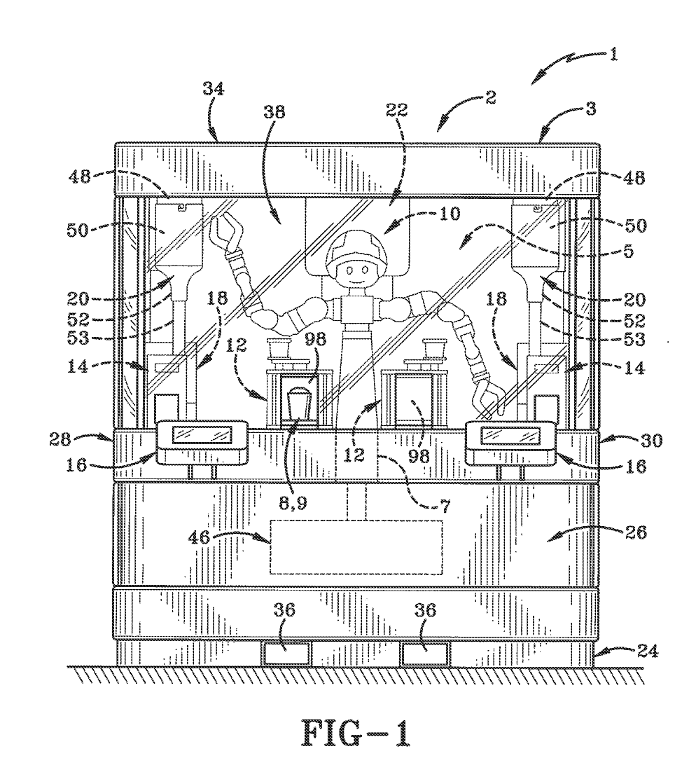

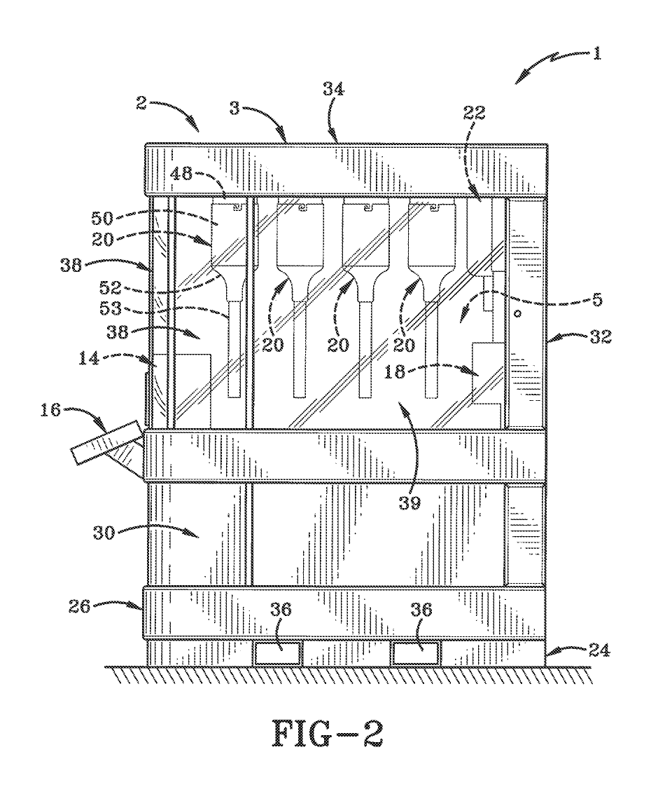

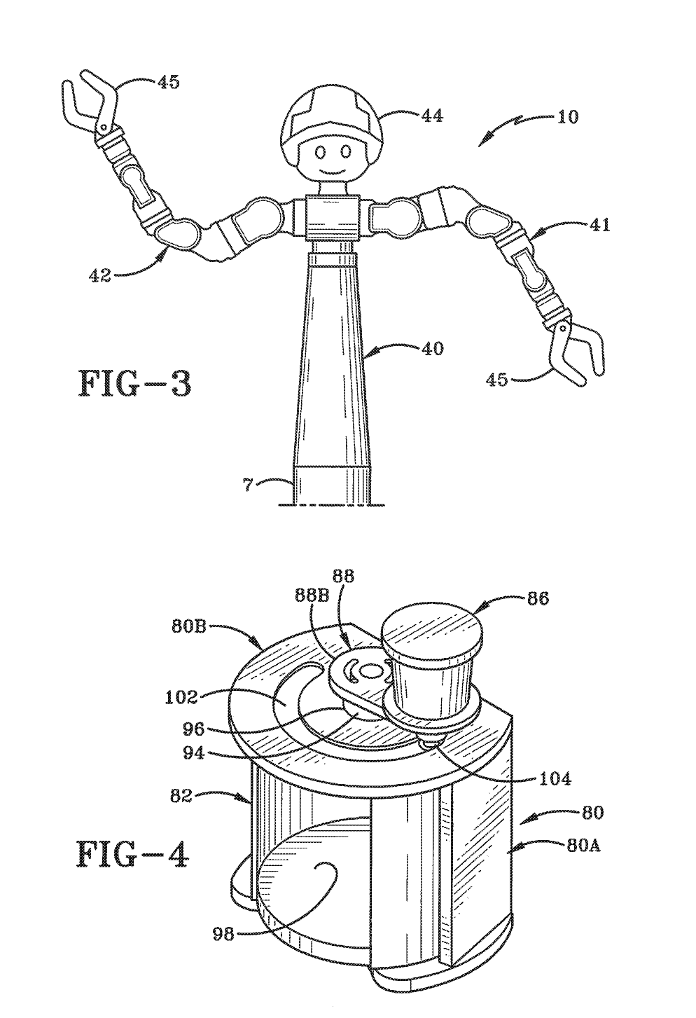

Referring to FIGS. 1 and 2, the preferred embodiment of the invention includes a dispensing system 1 that includes a housing 3 with an interior 5. In some configurations, the system 1 may be a self-contained kiosk 2. A robot base mount 7 is located generally in the central area of the interior 5 and a two armed robot 10 is mounted on robot pedestal 40 that is mounted on the robot base mount 7. Some of the other major components of the system 1 include a pair of product delivery assemblies 12, a pair of cash machine assemblies 14, a pair of user interfaces 16, a pair of cup dispensers 18, one or more topping dispensers 20 and one or more chilled product dispensers 22. The chilled product dispensers 22 can dispense ice cream, frozen yogurt or the like. The topping dispensers 20 can dispense candy, sprinkles, nuts, granola, and the like. As discussed in greater detail below, the robot 10 can prepare two different treats 8 and deliver them in two separate cups 9 or other containers to two different users at the kiosk 2 at the same time.

The housing 3 is generally rectangular in shape and has a floor 24, a front wall 26, a left wall 28, a right wall 30, a back wall 32 and a top wall 34. The floor 24 can have openings 36 formed in it to allow forklift prongs to be inserted into them to allow a forklift to lift and move the system 1. Alternatively, the system 1 can have wheels mounted on its floor 24 to allow it to be more easily moved from one location to another. Preferably, the front wall 26, left wall 28, right wall 30 and back wall 32 have transparent viewing windows 38 to enable the user to view the consumable product as it is being made. The windows 38 and/or portions of the walls can be unlocked, then opened and later relocked. For example, window 39 in the right wall 30 acts as a hinged door and can be locked to prevent unauthorized entry into the kiosk 2. A similar door can be included in the left wall 28 and/or the back wall 32. Those doors allow for easy access to the interior 5 of the housing 3 so that the cup dispensers 18, topping dispensers 20 and/or chilled product dispensers 22 can be refilled. The floor 24 may have a drip tray assembly for collecting spilled candy, ice cream and other products mounted thereon. The drip tray assembly may have tapered surfaces for directing spilled materials to specific locations.

In some applications, the interior 5 of the kiosk 2 is a refrigerate environment, for example, when ice cream or other products are to be served be the kiosk 2 that are to be kept chilled. In those cases, the walls of the kiosk may be air tight and so that very little air escapes from the kiosk 2 except when a product deliver assembly 12 is opened as described below. The robot 10 has the ability to operate in this cooled or frozen environment within the kiosk 2.

In the preferred embodiment, the robot 10 has a left arm 41, a right arm 42 and a head 44. The robot 10 may be a robot similar to Yaskawa's Motoman SDA5 robot or another robot. In the preferred embodiment, the robot 10 has 15 axes of motion (seven axes in each arm, plus an axis for base rotation). The robot's motion can be actuator-based so that its motions appear to have “human-like” flexibility with fast acceleration. Movements and personalities of the robot 10 will be discussed later. Of course, the robot 10 can be any suitable robot and can even be a custom built robot.

In the preferred embodiment, the user interfaces 16 can be touch screen devices and they may function similar to a laptop computer and/or tablet computer type of device. The user interfaces 16 are the human machine interfaces (HMIs) that allow a customer to at any time, while a treat is not being built, select various screens or help information to allow them to order their treat. The use of the user interfaces 16 will be discussed further below. The user interfaces 16 are preferably positioned so that they can be comfortably and effectively operated by users/customers of different heights. Access to the user interfaces 16 may be enhanced by the presence and/or operation of stationary or retractable stairs, elevators, platforms, and the like. Such features may also be utilized by a user to increase visibility of the interior portion 5 of the vending machine 10 in order to enhance the vending occasion and/or experience.

The cash machine assemblies 14 can include a cash device and/or a credit device. The cash device can accept currency in the form of bills, coins, and/or coupons wherein they are counted and proper change may be returned. When enough currency has been entered for the treat requested on a corresponding user interface 16, the cash machine assembly 14 can signal this to a vending controller logic 46 (discussed later) that can initiate the building of the desired treat. Alternatively or in addition to collecting cash, the credit card readers can read credit card information, debit card information and the like and debit the cost of the desired treat form a corresponding account.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

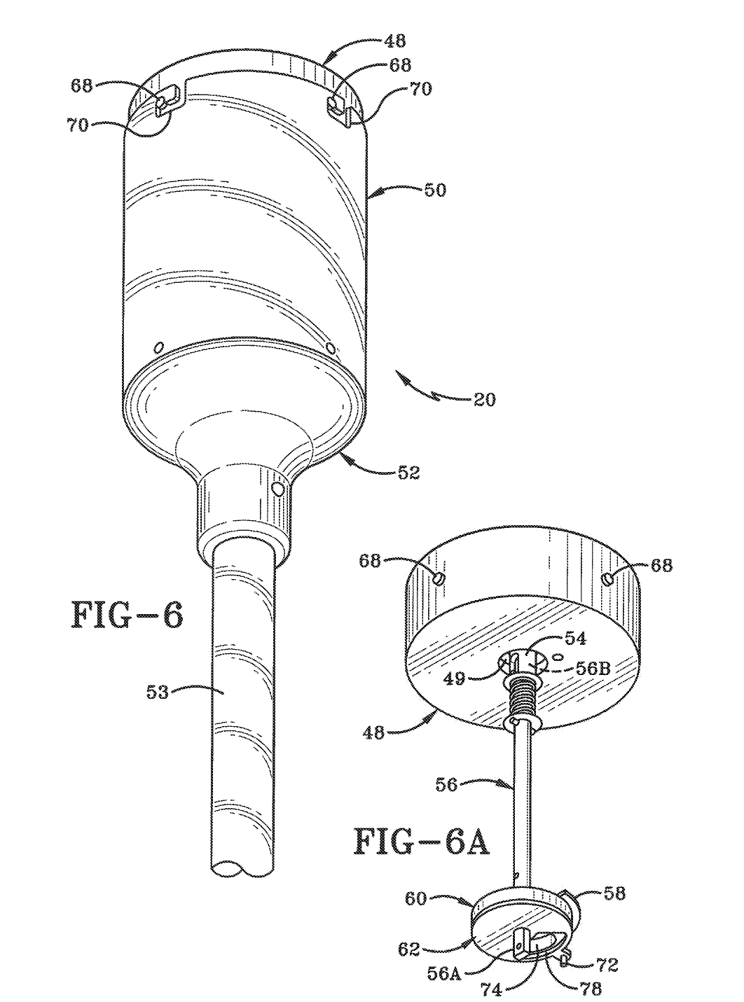

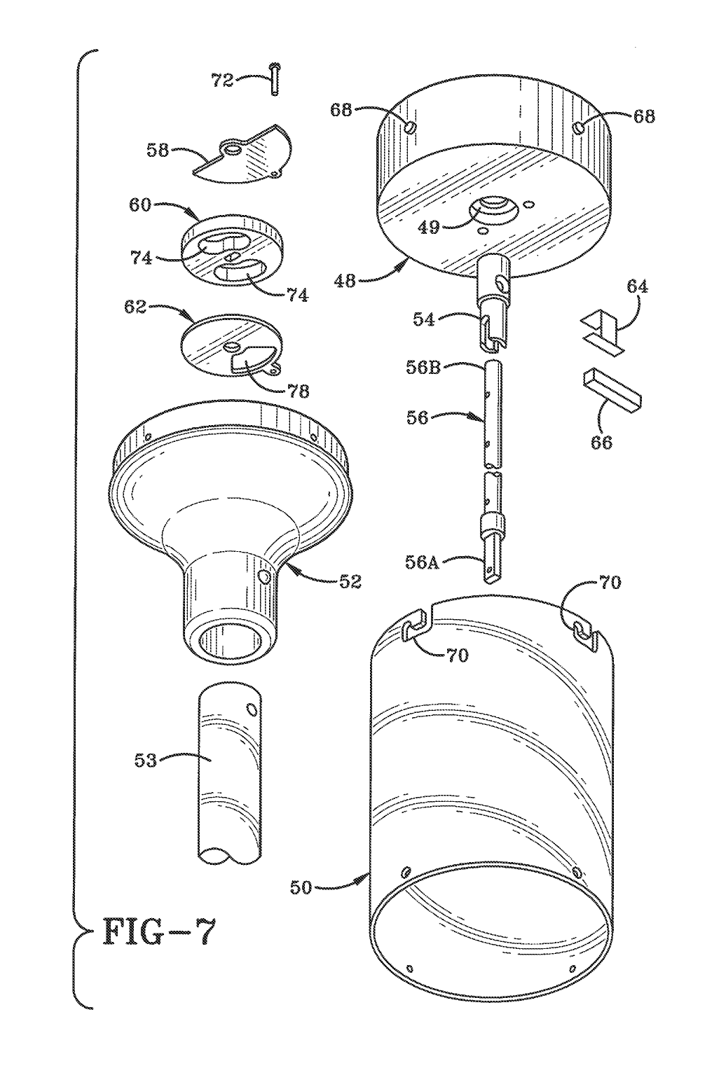

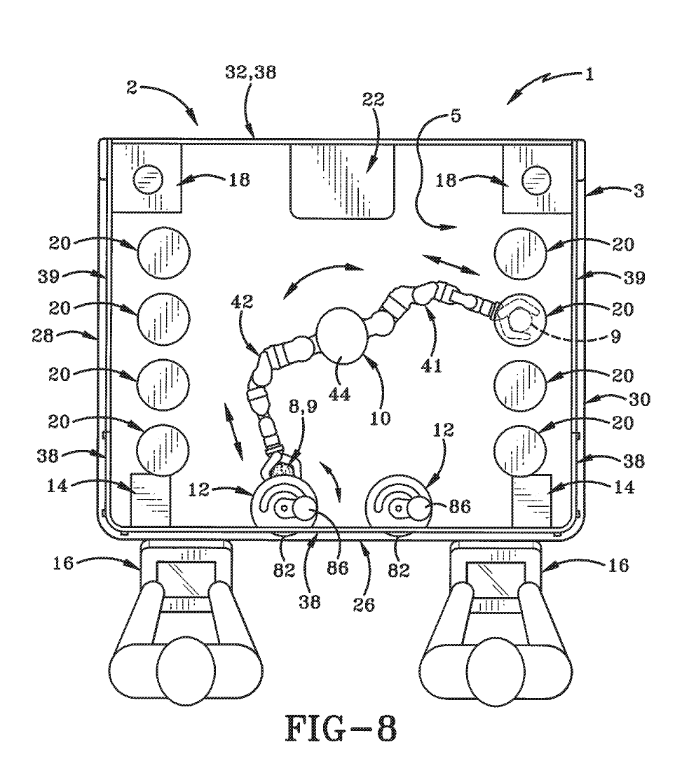

The primary components of a topping dispenser 20 include a ceiling mount hub 48, a topping container 50 and a valve housing 52. The hub 48 is generally disc-shaped and has outward projecting pins 68 while the topping container 50 has generally L-shaped cutouts 70. The topping container 50 is locked onto the hub 48 by twisting and maneuvering the candy housing 50 so that the pins 68 move through the cutouts 70 until the pins 68 are within the innermost portion of the cutouts 70 (see FIGS. 6 and 7). In the preferred embodiment, the hub 48 is formed out of plastic and the topping container 50 is formed out of clear plastic such as Delrin®.

A motor 49 (FIG. 7) is housed in the ceiling mount hub 48. A motor drive shaft 54 extends from the motor 49. A main drive shaft 56 with bottom 56A and top ends 56B is connected to the motor drive shaft 54 at its top end 56B. The bottom end 56A of the main drive shaft 54 passes through openings in a valve top plate 58 and a valve bottom plate 62. The valve top plate 58 and a valve bottom plate 62 are secured to the valve housing 52 so that they cannot rotate by passing a fastening device 72 such as a screw or a rivet through openings in the valve top and bottom plates 58, 62 and then into the valve housing 52. A candy disk 60 is located between the valve top plate 58 and the valve bottom plate 62 with the bottom end 56A passing through and connecting to the disk 60, as best seen in FIG. 6A. In the preferred embodiment, the motor 49 turns shaft 56 which in turn rotates the candy disk 60 between the valve top plate 48 and the bottom plates 62. The disk 60 contains two openings 74 that control the amount of candy (or other treat) to fall from the topping container 50 through the valve housing and down though a delivery tub 76. For example, when the motor 49 has rotated the candy disk 60 through the main drive shaft 56 until one of the disk openings 74 is not covered by the valve top plate 58, candy from the topping container 50 can fill that disk opening 74. As the disk 60 is further rotated, it will eventually align with a similar opening 78 in the valve bottom plate 62. When this happens, the candy in that disk opening will fall through the valve housing 52 downward through a delivery tube 53 to a cup held under the delivery tube 53 by the robot (as discussed further below).

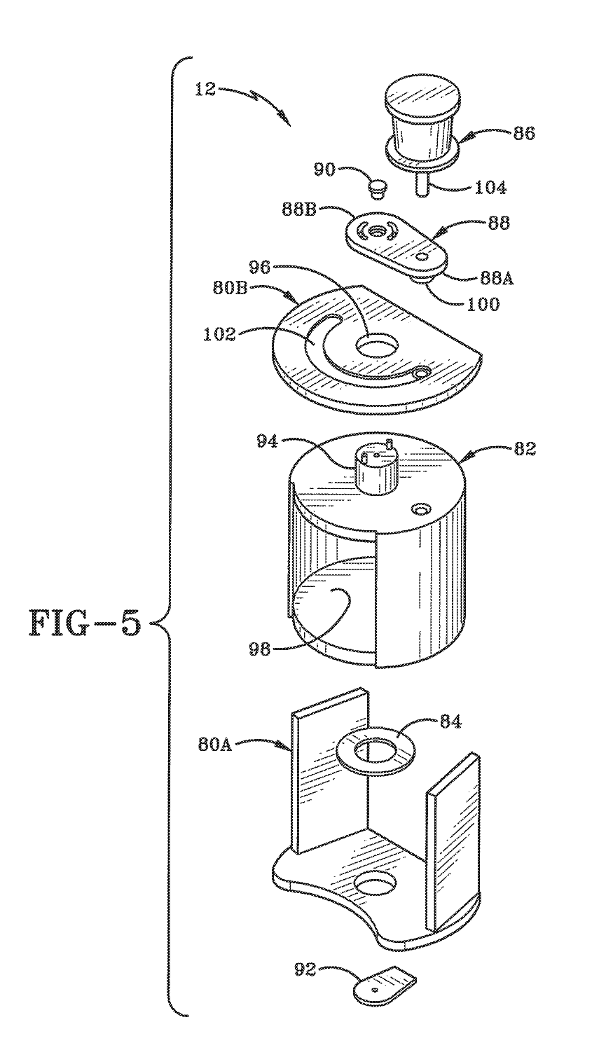

As illustrated in FIGS. 4 and 5, the preferred embodiment of the product delivery assembly 12 includes a product delivery frame assembly 80 that includes a lower frame portion 80A and an upper frame portion 80B, a delivery plate assembly 82, a Teflon® bearing 84, a control knob assembly 86, a drive arm assembly 88 with a first end 88A and a second end 88B, a bushing 90 and a sensor actuator arm 92. When the product delivery assembly 12 is assembled, the upper frame portion 80B is attached to the lower frame portion 80A with fasteners such as screws or other fasteners. The delivery plate assembly 82 is rotatably mounted within the product frame delivery assembly 80 and the Teflon bearing 84 can be located between a bottom wall of the delivery plate assembly 82 and the lower frame portion 80A.

In the preferred embodiment, the delivery plate assembly 82 is cylindrical in shape with an opening into an interior chamber 98. A cylinder-shaped portion 94 projects upward from a top wall of the delivery plate assembly 82 through an opening 96 formed in the upper frame portion 80B. The second end 88B of the drive arm assembly 88 is rigidly connected to the upper portion of the cylindrical portion 94 of the delivery plate assembly 82. The bushing/spacer 90 can be used in creating this attachment. The first end 88A of the drive arm assembly 88 is connected to the control knob assembly 86. Preferably this is a rotatable connection allowing the control knob assembly 86 to rotate about an axis passing through the first end 88A of the drive arm assembly 88. When the product delivery assembly 12 is assembled, a cylinder/shaft 100 on the first end 88A of the drive arm assembly 88 projects downward into a semicircular-shaped groove 102 formed in the upper frame portion 80B. Additionally, a downward projecting shaft 104 on the control knob assembly 86 can also project downward into a semicircular-shaped groove 102. The cylinder/shaft 100 and the downward projecting shaft 104 of the on the control knob assembly 86 combine to form a projection that travels within the semicircular groove 102 in the upper frame portion 80B as the product delivery assembly 12 is moved between open and closed positions.

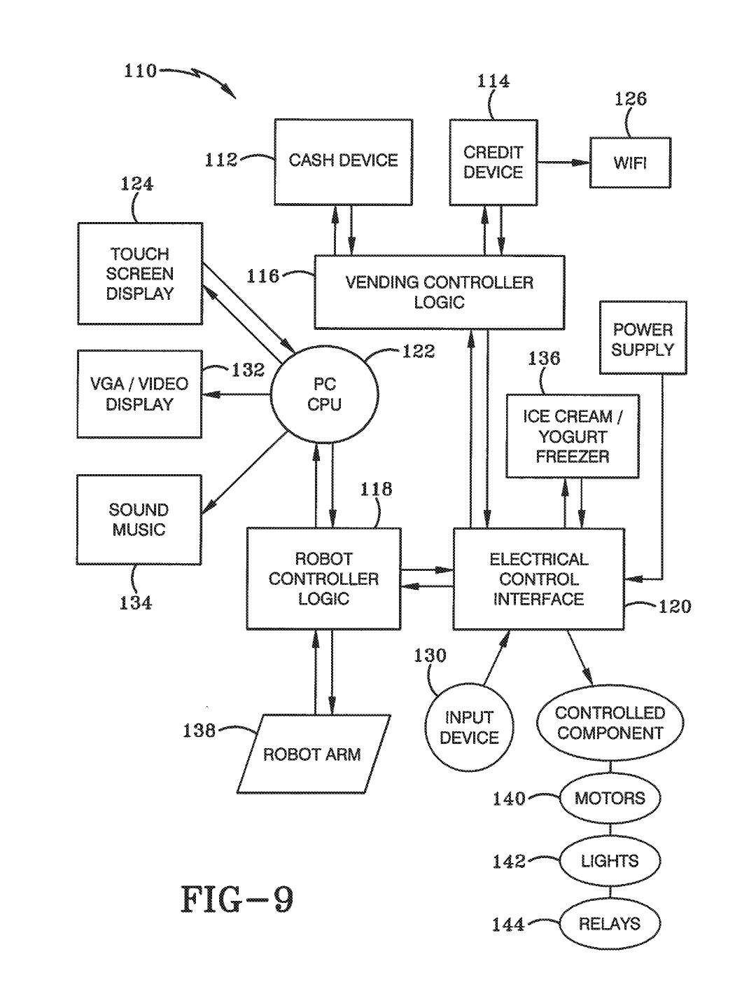

FIG. 9 illustrates an example configuration of some of the components of a system 110 implementing the dispensing system 1 discussed above. The system 110 includes a cash device 112 and a credit device 114. In general, everything except the robot controller logic 118 in FIG. 9 is duplicated for each half of a kiosk that can serve two users at the same time. The cash device 112 may perform some operations that are similar to the cash machine assembly 14 discussed above. Bills, coins and coupons can be fed into the device and counted. For example, if five dollars is required for purchase, $5 cash is fed into the cash device 112 and it acknowledges that a purchase has been made. It then signals a vending controller logic 116 that a purchase has been made. The vending controller logic 116 then sends a signal to a robot control logic 118 via the electrical control interface 120 (ECI). The robot control logic 118 sends via Ethernet a signal to a computer 122 that may be a personal computer (PC) with a central processing unit (CPU). Then, the computer 122 starts a program that allows a customer to enter their order into a touch screen display 124. The credit device 112 can be a credit card reader that operates similar to the case device 114 but also has the ability to communicate over a WIFI 126 with a remote credit card processor to verify the purchase and then signal the vending controller logic 116.

The touch screen display 124 may operate similarly to the user interface 16 described above. The touch screen includes a HMI (Human Machine Interface) for order entry as well as providing instructions. A customer at any time, while two treats are not being built, can walk up to the system 1 (e.g., kiosk) and select various screens and view the help information showing them how to run the kiosk. A technician can be given a proper password into the computer 122. By logging into the computer 112 he can run software that allows him to configure the different components of the kiosk 2. For example, he can access a setup area of a configuration software where different kiosk settings can be specified. For example, the number of turns for each candy can be entered in that software and stored in the computer 122. Additionally, what candy is in what dispenser can be specified and what flavor of ice cream or yogurt is in a freezer 136 can be specified. These setting, when changed, are transferred and set in the robot control logic 118 for the operation of the kiosk 2.

The vending controller logic 116 outputs signals to the system 110, based on the credit interface 114 or the cash device 112 acceptance of payment by the customer. It receives information from the computer 122 letting a program in the vending controller logic 116 know when to re-enable the credit device 114 or the cash device 112 for new purchases.

An input device 130 can be used to send inputs to the electronic control device 120. There may be multiple input devices 130 connected to the system 110. The input device 130 can be a button, sensor, micro-switch, or other device used to signal counts, positions, presence of items or other information to the system 110. For example, an input device 130 in the form of a sensor is used on the topping dispenser 20, to count the number of turns. For example, dispensing M&M's may need four turns and dispensing “sprinkles” may need two turns. This sensor can monitor a cam which allows one signal (count) per turn. This signal is input to the electronic control interface 120 and is then registered in the robot controller logic 118. The actual counting is performed in the robot controller logic 118. When it sees the appropriate number of counts, it turns off the motor that is turning the topping dispenser 20

The vending controller logic 116 can disable the cash device 112 and credit device 114 until a current operation is performed. It can also receive signals from external cash, coin, coupon, credit card, token devices and the like. It then signals other external devices that a purchase has been made. It can also receive a blocking signal that will not allow another purchase until that signal goes away.

The system 110 can provide a variety of outputs. For example, the touch screen display 124 displays information about the progress of the user's treat with pictures while the user's treat is being built. It can also display help information. The system 110 can also include a video graphics array (VGA)/video display 132 for playing advertising and video information. During treat building, the video display 132 will be displaying information according to a character chosen as discussed further below. In the preferred embodiment, there are four different characters and four groups of videos but there can be any number of characters/personalities. An advertising video is shown when no treat is being built. A sound/music system 134 can provide music and sound to enhance the customer experience. During treat building, the sound will correspond with the character chosen; since there are four different characters there are four different groups of music which can be played as well.

An ice cream/yogurt freezer 136 produces ice cream or yogurt to be dispensed by the robot. A low mix signal is provided back to the robot control logic 118 which signals a light (that may flash once every second) that the mixture is low.

In the preferred embodiment, the computer 122 is a personal computer running that runs “Robofusion Software” for the HMI. The computer 122 also controls video and music being played as well providing video for help and advertising. It also retrieves treat build information from a user via the touch screen display 124 and transfers this information to the robot control logic 118 so that the product can be built and delivered to the customer by the robot arm 138.

In the preferred embodiment, the robot control logic 118 handles all input and output logic, as well as controls the robot arm 138 itself and maintaining its positions. All input and all output is handled by this robot control logic 118 through the electrical control interface 120. The robot control logic 118 communicates with the computer 122 through its own proprietary communications over an Ethernet communication link. The electrical control interface 120 interfaces all electrical power and components to the robot control logic 118 using relays, breakers, contactors, power supplies, and/or terminal blocks that can be mounted in an Intertek Testing Services/Canadian Standards Association (ETL/CSA) approved control panel. The electrical control interface 120 can interface with various controlled components that may include motors 140, lights 142, relays 144, and devices electrically controlled by the system to deliver cups, frozen product and entertainment.

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

In one preferred embodiment, the kiosk 2 is capable of providing at least two different ice cream flavors and at least 10 different toppings. The order of the addition of the different flavors and the different toppings may be controlled by the customer. Examples of ice cream flavors that may be supplied include but are not limited to vanilla, chocolate, and various fruit flavors. Each ice cream flavor may be supplied as a pre-formulated product or as a base wherein the flavorants are added at the time of selection by the customer. It will be understood that the method in which the ice cream is produced, formulated, and dispensed may be implemented in various ways. For example, ice cream may either be mixed and frozen fresh by the chilled product machine 22 or made offsite and delivered to the machine chilled product machine 22. Any suitable automated method for dispensing the ice cream or other treat may be employed.

The ice chilled product dispenser 22 is configured to deliver control portions of ice cream from a bag. However, in another configuration of the preferred embodiment, the chilled product dispenser 22 can be configured to deliver ice cream from pre-packaged containers, each with an individual serving portion contained inside. For example, the ice chilled product dispenser 22 could be able to deliver single servings of ice cream from somewhat “hockey puck”-shaped containers similar to the ones produce by One-Shot® Corporation Limited in the United Kingdom. A delivery system could be built and incorporated into the kiosk 2 that vertically stacked hockey puck-shaped servings of ice cream, yogurt and the like for dispensing one at a time.

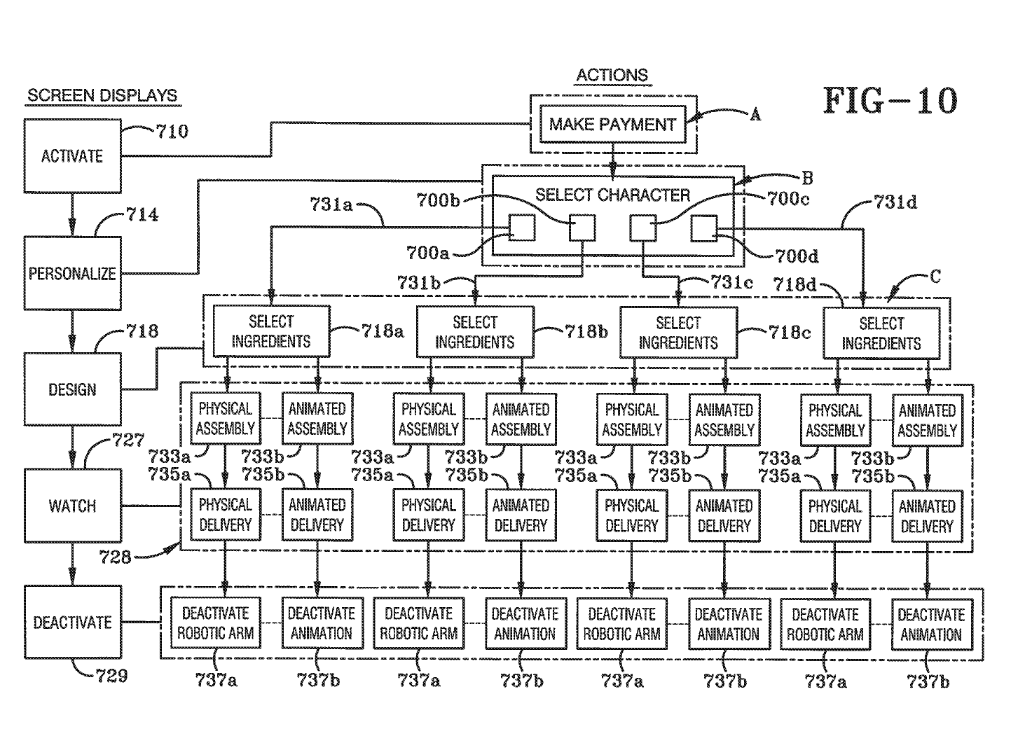

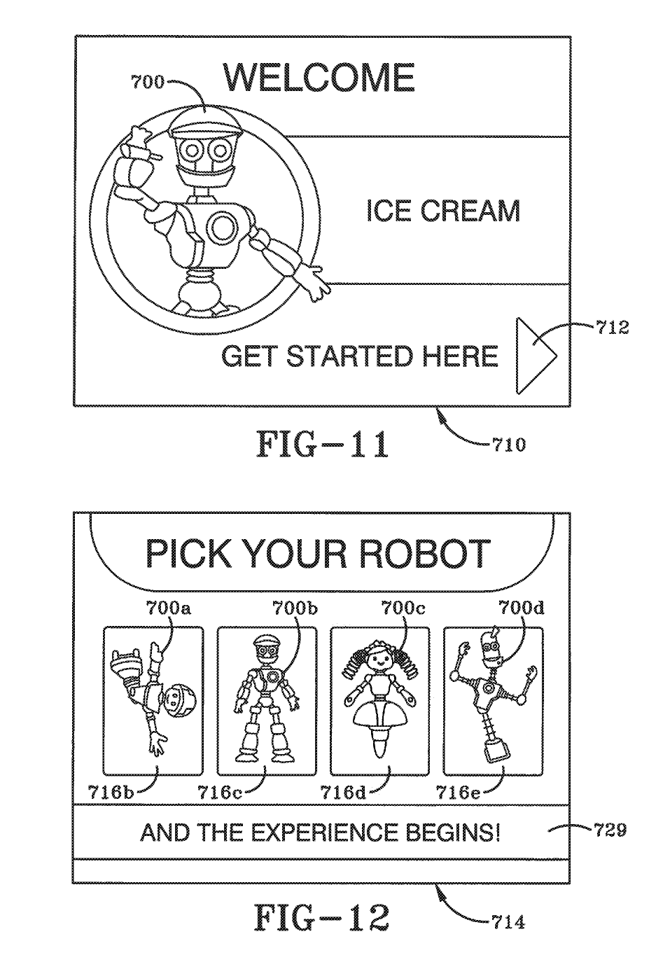

FIG. 10 illustrates some of the actions of one method of operating the system 1 described above. FIG. 10 will be briefly described with an entire overview of its operation and then it will be described in more detail below with references to FIGS. 11-15 and screenshots of a display used to implement portions of FIG. 10. The method of FIG. 10 begins by activating the kiosk, at 710. The activation may occur when a user makes a payment as indicated by reference character “A”. Next, the user is prompted to personalize their robotic character, at 714. For example, the display can prompt the user to select between one of four characters 700a-d at reference character “B”.

After a robotic character is selected, the method can then prompt the user to design their treat, at 718. Each robotic character can as illustrated with reference character “C” independently prompt the user to select their ingredients. For example, select ingredient blocks 718a-d prompts the user to select ingredients through a display using the personality of their selected robot. Next, at 727, the user can watch the robot assemble their treat. Block 728 illustrates that each of the four robotic characters can each individually physically (with a robotic arm) and animatedly (on a display device) perform different physical assembly 733a-d and animated assembly 733b actions as well as different physical delivery 735a and animated delivery 335b actions. After the treat has been delivered, the robot can be deactivated, at 729. Again, the robot or one of its robotic arms can be individually physically deactivated 737a as well as independently graphically deactivated 737b on a display device.

Now the method of FIG. 10 will be described in more detail with additional reference to FIGS. 11-15. When a potential user approaches kiosk 2, music is playing through speakers and lights may be flashing. The music and lights may be motion activated. A colorful, welcoming first screen display 710 (See FIG. 11) lights up on the user interfaces 16. The user interfaces 16 are preferably of such a nature that they can be easily operated by persons as young as two years old. It will, of course, be understood that any other type of user interface that permits the user to view or hear how to operate the kiosk 2 is considered to fall within the scope of this invention. The following description references how to operate the user interface 16 and the manner of selecting and inputting information into the same. It will be understood that other methodology that is specific to other types of user interfaces for reviewing and inputting data will be appropriate for the particular interface provided on kiosk 2.

FIG. 11 is exemplary of a first screen display 710 that welcomes the user to kiosk 2. First screen display 710 shows a first character 700 that personifies the robot 10 used in the kiosk 2. The term “characters” as used herein should be considered to cover all types of images that can be selected by the user. These can include robotic characters, as depicted herein and as used in the preferred embodiment of the invention, cartoon characters, letters, numbers, symbols, photographs or any other type of selectable visual image. The term “robotic characters” as used herein should be broadly interpreted as any type of graphic representation that is selectable by the user.

First screen display 710 invites the user to begin assembly of their treat. The user activates the machine by paying with any acceptable form of payment such as that as shown in FIG. 10 by the reference character “A”. Although not illustrated herein, payment may be made in any format including inserting coins or bills into a pay slot in the cash machine 14, inserting tokens into a pay slot, swiping a card through a card reader, entering a number into the user interface or scanning any required or acceptable payment means. First screen display 710 appears on user interface 16 immediately prior to or immediately after the user has made payment by any acceptable method. The user touches the start indicator 712 on first screen display 710 to advance to a second screen display 714.

The enhanced computer programming in computer 122 allows the user to personalize his or her experience for assembling their treat. The action of personalizing the experience is referenced by “B” in FIG. 10 and a second screen display 714 relating thereto is also shown in this user interface 16. Kiosk 2 can permit the user to select a treat such as various frozen confectionaries with toppings that will be used to assemble their personalized frozen treat. Kiosk 2 is additionally provided with enhanced computer programming that permits the user to select an animated robotic character 700a-700d to walk and coach them through the assembly procedure. As shown in FIG. 12, a second screen display 714 includes a plurality of display regions 716b, 716c, 716d, 716e, each of which is provided with an image of one of a plurality of programmed virtual robotic characters 700a, 700b, 700c, 700d thereon. Robotic characters 700a-700d are utilized to increase the personal interaction of the user with kiosk 2 as they appear to coach and guide the user through the assembly process.

It will be understood that any one of a number of different virtual robotic characters may be displayed on second screen display 714. A separate display region will be provided on second screen display 714 for each additional available robotic character. In the preferred embodiment, the user is provided with the option of selecting one of four robotic characters.

As an aside, it should be noted that the kiosk 2 may display graphic images at the consumer interfaces 16 related to the variety of different virtual robotic characters available on that particular kiosk 2. Furthermore, robotic characters 700a-700d may be customized for the particular vending location and specific client in which kiosk 2 is provided. So, for instance, if kiosk 2 is provided in a theme park of some nature, then characters that are associated with the particular theme park may be displayed in display regions 716b-716e as well in as graphic images on the exterior of kiosk 2.

When the user touches any one of the display regions 716b-716e, a short animated vignette may be displayed on user interface 16 relating to the specific robotic character 700a-700d that was touched and highlighted. So, for instance, if the robotic character selected is the one identified by reference number 700a and associated with display region 716a, for instance, the character could be animated to appear to skateboard and will be accompanied by sounds and music that are representative of that type of motion. If the robotic character selected is the one identified as 700c on display region 716c instead, then that robotic character 700c could be animated to move as though they are a ballerina and the sounds and music accompanying that character 700c will be appropriately linked to that type of activity. In other words, each specific robotic character is programmed to move in a unique fashion accompanied by sounds and music associated with the character and with the type of movement. The sounds and/or music are generated by the computer and played over loudspeakers at the kiosk 2. Additionally, lights may be caused to flash in a pattern that is linked specifically to the robotic character 700a-700d. In order to select a particular desired robotic character, the user leaves their selection highlighted on second display screen 714 and touches the activation indicator 729 thereon.

This selection causes a third screen display 718 (FIG. 10) to appear on the user interfaces 16. As shown in FIG. 10, the selection of each robotic character can set up one of a unique set of animated tracks 731a, 731b, 731c and 731d. Of course, there can be a different number of characters and corresponding tracks and four of them are discussed here for illustration purposes only. These tracks are operable on a second circuit sequence provided in kiosk 2. One of the plurality of animated tracks 731a, 731b, 731c and 731d being automatically initiated upon entry of the first user input.

The animated tracks, which are pre-programmed and stored in the computer 122 operationally linked to user interface 16, each comprise a unique and character-specific animation sequence, a music selection and/or sound selection, and/or lighting patterns. The animated tracks are linked via user interface 16 with the movements of robot 10. This arrangement allows the user to control their own personal experience with kiosk 2 in that they are able to select the type of animated visuals, music, sounds and lighting that appeals to them and will entertain them as they wait for their treat to be made. As there are four robotic characters 700a, 700b, 700c and 700d, this selection sets one of four music tracks in kiosk 2 that correspond with the selected robotic character. Additionally, the selection sets one of four animation tracks that appear to “play” and “interact” with the user. Finally, the selection of the robotic character may also set a series of runs of robotic movements that will accompany the assembly of the treat.

Regardless of which of the robotic characters 700a-700d is selected, the next action that is undertaken by the user is the selection of the ingredients that they wish to include in their treat. The ingredient selections are part of a third circuit sequence operatively connected to the user interface 16.

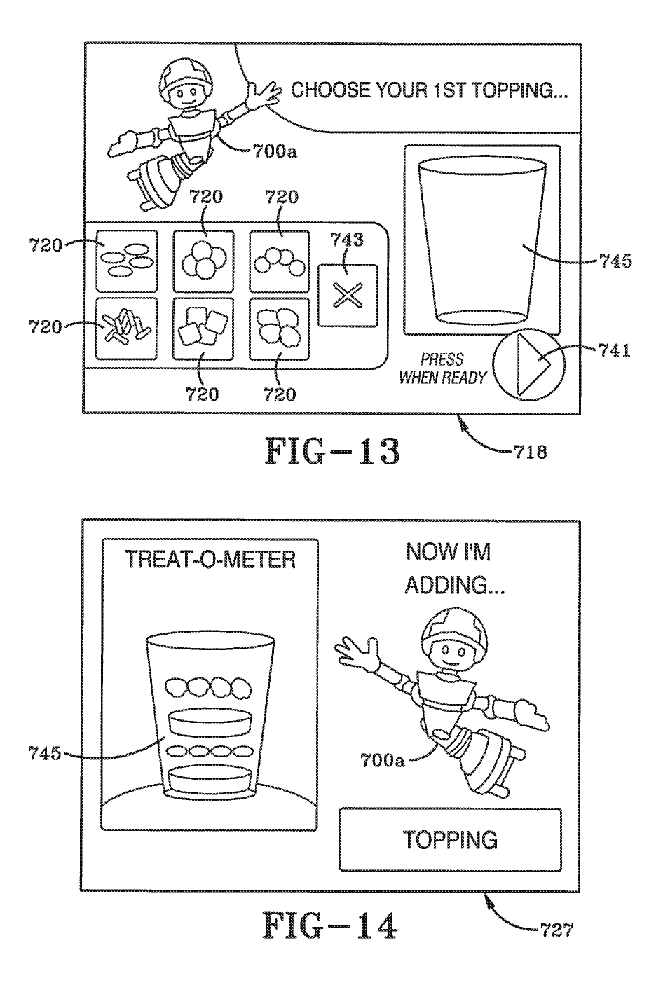

The act of selecting the ingredients is indicated by the letter “C” in FIG. 10. A customized third display screen 718 appears on user interface 16. The particular third display screen is dependent upon which robotic character was selected in step “B”. The possible third display screens are indicated as 718b, 718c, 718d and 718e. The following description will presume that the user selected robotic character 700a. A third screen display 718a (FIG. 13) offers the user a plurality of ingredient options for their review and selection. Each ingredient option is displayed on an individual display region 720. The user is prompted through one or both of the visual and audio cues provided by the selected robotic character 700a to select a cup for the treat and to select the various ingredients they wish to have therein. The user may make between 1 and 4 (or more) ingredient selections as the treat is constructed from four layers of ingredients. The ingredients can include any one of a number of frozen confections including but not limited to ice cream, sorbet, custard, frozen yogurt and chipped or shaved ice. The ingredients further include any one of a variety of toppings including a range of syrups, candies and nuts. The computer may be programmed to always present the same options for the frozen confections and toppings or may be programmed to include special ingredients that are only offered during promotions or seasons such as candy cane flavored ice cream at Christmas or candy corn candy toppings at Halloween. The ice chilled product dispenser (or other type of dispensing stations) for the frozen confections and toppings are filled with the same ingredients that are presented for selection by the computer. An ingredient may be dispensed as many times as the user selects. Additionally, the order of ingredients can be completely selected by the user. The user can make their selections in the order they choose for the machine to assemble their treat. Selection of each ingredient is made by touching and therefore highlighting the desired display region 720 and then touching the advance indicator 741. The selection is accompanied by some type of visual and/or auditory confirmation by the selected robotic character 700a and may also be accompanied by flashing lights and/or sounds. The third screen display 718a can also include a region 743 for removing an ingredient or for switching the ingredient layers around before a final confirmation is given. As the user makes their selections, a graphic 745 of the cup on third display screen 718 can visually illustrate the layers of the treat being placed into the physical cup.

Once the user is happy with their virtual end product as shown on third screen display 718, they initiate the building of their treat by touching a proceed indicator 741 on third display screen 718. This action signals to the computer 122 to begin with the physical assembly of the treat. At this point, the user's next action is for them to watch the assembly of their treat. This is indicated in FIG. 10 as step 727. Step 727 covers two phases: 1.) the assembly of the treat, and 2.) the delivery of the finished product.

To begin the assembly process, the computer 122 sends a signal to activate the robot 10. The robot 10 goes about assembling the treat within interior 5 of kiosk 2 according to the selected parameters entered by the user. The enhanced programming provided in the computer 122 synchronizes the actual physical assembly of the treat by robot 10 using its left arm 41 and its right arm 42 to perform different tasks in an animated way. When there is only one user at the kiosk 2, both robot arms 41, 42 can be used to assemble different portions of the treat. For example, the left arm 41 can hold the cup under a topping dispenser 20 located on the left side of the kiosk for dispensing a first topping and the right arm 42 can be used for holding the cup under a topping dispenser 20 on the right side of the kiosk. Also, when only one user is at the kiosk 2, the robot 10 will only represent the one character selected by the user so that both arms 41, 42 and the head 44 will be controlled to act as a single character selected. Note that in some configurations, the head 44 can physical move or simulated facial features on the head can be controlled and moved. In some configurations, light and/or images on the head can be controlled to give the appearance that the head 44 is playing the part of a selected character.

However, when two users (a first user and a second user) are each ordering a treat at the respective user interfaces 16, the robot 10 can begin to create the first treat for the first user using both of its antis 41, 42 once the first user has specified that treat. The robot 10 can also use both its arms 41, 42 and head 44 to act as the character selected by the first user once the first user has specified their treat. Once the second user has finished specifying their treat and their selected character, the robot 10 can begin building the second treat using one of its arms 41, 42. While building both treats, the left arm 41 is building the first treat and the right arm 42 is building the second treat. The left arm 41 can act as a first character and the right arm 42 can act as a second character. The head 44 may take turns acting one character and then the other or in some configurations, different parts of the head can simultaneously act out portions of each character. If the first treat is completed before the second treat, then the entire robot 10 can act as the second character and both arms 41, 42 can be used to create the second treat. If a subsequent user specifies another treat at the free user interface, the robot 10 can then revert back to making two treats at the same time and acting as two characters at the same time. In the preferred embodiment, both arms 41, 42 work independently to prepare each treat when two treats have been requested; however, it is envisioned that in some configuration there will be times when the other arms may work together to prepare one treat at the same time while the production of the other treat is temporarily suspended. For example, a first treat being built by the right arm 42 may need to access a topping dispenser on the left side that is only accessible by the left arm 41. In that case, the creation of second treat may be momentarily suspended when the first treat is passed from the grabber 45 of the right arm 42 to grabber 45 of the left arm 41.

As illustrated in the flow chart shown in FIG. 10, the user is therefore able to physically watch the robot 10 assemble the treat according to their specifications. This is represented by the block 733a on FIG. 10. The user is also able to simultaneously watch their virtual robotic character 700a “aid” in the assembly of the treat on the supplied display, in real time. This is represented by the block 733b on FIG. 10 and is shown in FIG. 14 on a fourth screen display 727. The overall effect on the user is that their selected robotic character 700a is helping in the process. The physical assembly 733a by the robot 10 is accompanied by flashing lights and sounds that are preprogrammed to be linked to the selected robotic character 700a. Similarly, the animated virtual assembly 733b of the treat on the display 376 includes a variety of moving and/or changing images that show the confection being assembled layer by layer in synchronization with the robotic arm 316.

During the initial stages of the physical assembly process, the robot 10 first can do a little “dance” to music, meaning that it arms 41, 42 can be rotated back and forth with a portion of the arms 41, 42 being rotated up and down and around in time to music and sounds that are played by the kiosk 2. Lights can also be made to flash in synchrony with the music and sounds. Preferably, the “dance” is preprogrammed to be specific to the robotic character 700a. Although not illustrated herein, once the “dance” is over, a signal is sent by the computer 122 to one of the cup dispensers 18 within the interior of kiosk 2 to open a door to a sanitary storage area (not shown). One of the robot arms 41, 42 is moved into position adjacent the door and the gripping end of that arm is positioned to receive a cup (e.g., cup or bowl). The computer 122 sends a signal to the cup dispenser 18 to dispense a single cup (FIG. 7). The gripping end grasps the cup and moves it away from the door to the dispensing station. The computer 122 then sends a signal to the cup dispenser 18 to close the door thereto. This dispensing of a cup on demand keeps all of the cups in the most sanitary environment possible.

In the preferred embodiment, the cup dispenser 18 has a motor, which turns a gear, which turns a cog, which turns a spiral, which dispenses a cup, while holding the remaining cups in place, only dropping the one cup. Turning on this motor for about three seconds latches its electrical circuit, and it runs until a cam opens the circuit by an electrical switch.

The robot 10 then moves the cup from the first location of adjacent the cup dispenser 18 to a second location within the interior of kiosk 2. The physical movement of the robotic arm is animated 733b on the display 376 and is accompanied by various actions and sounds made by robotic character 700a. To the user, it may appear that robotic character 700a is controlling robotic arm 16. The robot 10 moves the cup to the second location and the cup can be at the ice chilled product dispenser 22 or under a dispensing tube extending from one of the topping dispensers 20 that corresponds with the first ingredient selected by the user. This physical move is, once again, shown animated via the user interface 16. A pre-specified quantity of the selected first ingredient is dispensed from the ice chilled product dispenser 22 into the cup while the robotic arm retains the same under an opening at the ice chilled product dispenser. This physical action is, once again, visually shown on the user interface 16 accompanied by animated movements of robotic character 700a. The robotic arm can swing around and shows cup to the user through viewing window, an action that can be shown in animation on display as well. The robot 10 can then move the cup with the layer of the first ingredient in it to a location positioned beneath one topping dispensers 20 that holds the second preselected ingredient. A signal is sent by the computer 122, and a quantity of the second ingredient is layered onto the layer of the first ingredient. The user observes the second ingredient being dispensed physically by looking through window windows 38 of the kiosk.

The computer 122 can be programmed so that at some point during the dispensing of the preselected ingredients, the robot 10 “makes a mistake”. The mistake is a programmed “accidental” movement where one of the robot's arms 41, 42 is moved to a location under an incorrect dispensing tube. In other words, a robotic arm appears to be going to dispense an ingredient that was not selected by the user or appears to be about to dispense a selected ingredient but in the wrong order from that specified by the user. Robotic character 700a is programmed to appear to “catch” the mistake. The animation involved at this point is accompanied by appropriate noises and sounds. This interaction makes it appear that the robotic character 700a is controlling the physical robot 10 and is assisting in the construction of the treat. This “mistake” is designed to bring a heightened sense of anxiety, anticipation and relief to the user. It will be understood that any suitable programming and animation that enhances the entertainment aspect of the dispensing of the ingredients can be utilized without departing from the scope of the invention.

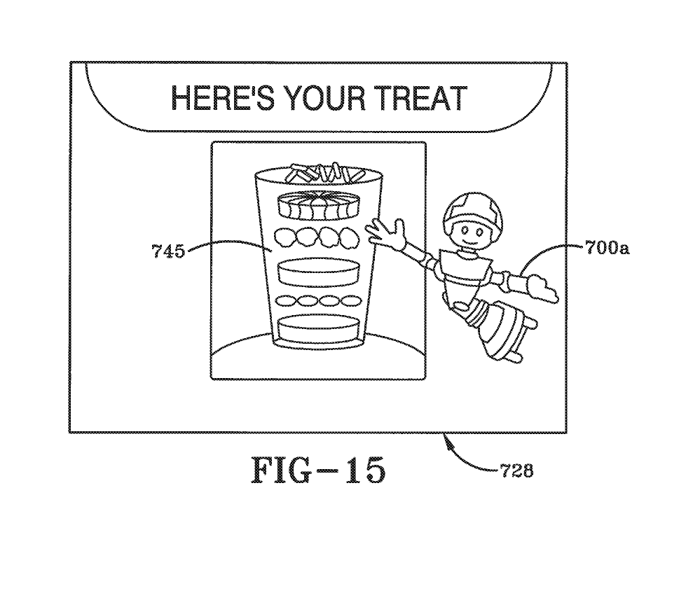

The physical movements of robot 10 continue until all layers have been introduced into cup and the treat is ready for delivery. The robot 10 then moves the treat from adjacent the delivery conductor of the last added ingredient to one of the product delivery assemblies 12. The physical delivery is indicated on FIG. 10 by block 735a and the animated delivery is indicated by block 735b thereon. Lights and sounds can be generated by the computer 122 to also indicate to the user that the finished product is ready and will be moved to a delivery area. The robot 10 places the assembled treat onto one of the delivery plate assemblies 82. This movement can also be shown visually on the user interface or on another display. The robot 10 can then grab the knob 86 of that product delivery assembly and move it in a circular motion to rotate the delivery plate assembly 82 until the treat is accessible to the customer. A final screen display 728 (FIG. 15) is brought up on user interface 16 indicating the treat is ready. Alternatively, the computer 122 can send a signal to a motor (not shown) operationally engaged with the delivery plate assembly 82 and rotate the delivery plate assembly 82 until the treat is accessible to the user. Although not illustrated herein, in another configuration, the delivery plate assemblies 82 can include a slip-clutch that will stop the rotational motion if the user touches the delivery plate assembly 82 before it has ceased rotating. After a lag time of about 45 seconds in which the user can remove the treat, the computer sends a signal to the motor to rotate the delivery plate assemblies 82 back to its original position. When the delivery plate assembly 82 is back in its original position, it is locked against rotation so that the user cannot move it. Once again, the movements of the robot 10 and the treat are displayed virtually on user interface 16 “hosted” by robotic character 700a. The entire assembly process takes anywhere from 5-40 seconds depending on the selections made by the user. The kiosk 2 can also include access ports (not shown) for dispensing napkins and spoons and the like to the user.

Once treat has been retrieved from the kiosk 2 by the user, one of the robots arms 41, 42 and robotic character 700a wave goodbye to the user accompanied by suitable lights, sounds and music and the kiosk 2 is deactivated. These actions are indicated on FIG. 10 by blocks 737a, 737b and 729, respectively.

In the foregoing description, certain terms have been used for brevity, clearness, and understanding. No unnecessary limitations are to be implied therefrom beyond the requirement of the prior art because such terms are used for descriptive purposes and are intended to be broadly construed. Therefore, the invention is not limited to the specific details, the representative embodiments, and illustrative examples shown and described. Thus, this application is intended to embrace alterations, modifications, and variations that fall within the scope of the appended claims.

Moreover, the description and illustration of the invention is an example and the invention is not limited to the exact details shown or described. References to “the preferred embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in the preferred embodiment” does not necessarily refer to the same embodiment, though it may.

What is claimed is:

1. A method of building a multi-layered edible treat at a kiosk comprising:
receiving payment at the kiosk from a first user for a first edible treat for the first user;
receiving payment at the kiosk from a second user for a second edible treat for the second user;
providing a robot having left and right arms;
using the left arm to maneuver a first holder for the first edible treat to a first location to receive a first edible portion of the first edible treat;
dispensing the first edible portion of the first edible treat into the first holder;
using the right arm to maneuver a second holder for the second edible treat to a second location to receive a first edible portion of the second edible treat; and
dispensing the first edible portion of the second edible treat into the second holder.

2. The method of claim 1 further comprising:
using the left arm of the robot to maneuver the first holder to a third location to receive a second edible portion of the first edible treat, wherein the first location is different than the third location;
dispensing the second edible portion of the first edible treat into the first holder;
using the right arm of the robot to maneuver the second holder to a fourth location to receive a second edible portion of the second edible treat, wherein the second location is different than the fourth location; and
dispensing the second edible portion of the second edible treat into the second holder.

3. The method of claim 2 wherein the first edible portion of the first edible treat is a cooled confectionery and the second edible portion of the first edible treat for the first user is a candy.

4. The method of claim 1 further comprising:
completing the first edible treat using the robot to produce a first completed edible treat;
delivering the first completed edible treat to a pickup location;
providing access at the pick-up location for the first user to receive the first completed edible treat.

5. The method of claim 4 wherein the providing access at the pick-up location further comprises:
opening a door at the pick-up location using the left arm.

6. The method of claim 5 wherein the opening the door further comprises:
grabbing a knob with a grabber at one end of the left arm; and
rotating the knob in a partial circular motion to open a cylindrically-shaped delivery plate assembly to provide access to the first edible treat in an interior opening of the delivery plate assembly.

7. The method of claim 4 further comprising:
completing the second edible treat using the left arm and the right arm.

8. The method of claim 1 further comprising:
cooling a confectionery at the kiosk, wherein the first edible portion of the first edible treat is the confectionery.

9. The method of claim 1 further comprising:
accepting a request for the first edible treat at a first user interface at the kiosk; and
accepting a request for the second edible treat at a second user interface at a different location at the kiosk than the first user interface.

10. The method of claim 9 wherein the accepting of a request for the first edible treat further comprises:
accepting each layer of the first edible treat as specified by the first user at the first user interface.

11. The method of claim 9 further comprising:
displaying on a graphical display on the first user interface instructions of how to select different layers of the first edible treat.

12. The method of claim 9 further comprising:
displaying on a graphical display on the first user interface video representations of actions of the robot as each layer of the first edible treat is performed by the robot.

13. The method of claim 1 further comprising:
completing the first edible treat using the robot to produce a first completed edible treat;
delivering the first completed edible treat to a pick-up location;
providing access at the pick-up location for the first user to receive the first completed edible treat; and
passing the second holder of the second edible treat from a gripper at one end of the right arm to a gripper at one end of the left arm.

14. The method of claim 1 wherein the first holder is a cup and further comprising:
dispensing the cup from a cup dispenser; and
grabbing the cup with a grabber at one end of the left arm.

15. The method of claim 1 wherein the dispensing the first edible portion of the first edible treat further comprises:
allowing a predetermined amount of the first edible portion of the first edible treat to fall downward through a delivery tube and into the first holder.

16. A vending machine for building custom ordered treats comprising:
an enclosed housing having windows for viewing custom treats as the treats are created;
a first user interface configured to accept inputs from a first user for a treat for the first user;
a second user interface configured to accept inputs from a second user for a treat for the second user; and
a robot with a left arm and a right arm and a simulated head above and between the right arm and the left arm; wherein the left arm and right arm are configured to work together to assemble a single treat when only one treat has been requested at the vending machine, and wherein when a first treat and a different second treat have been requested at the vending machine, the left arm is configured to work at least sometimes independently of the right arm on the first treat and the right arm is configured to work at least sometimes independently of the left arm on the second treat.

17. The vending machine of claim 16 further comprising:
a chilled product dispenser configured to dispense a chilled product, wherein the chilled product dispenser is accessible by both the right arm of the robot and the left arm of the robot.

18. The vending machine of claim 16, wherein the housing has a top, a bottom, a front side, a back side, a left side and a right side and further comprising:
a plurality of topping dispensers located along the left side and along the right side.

19. The vending machine of claim 16 wherein each topping dispenser further comprises:
a topping container that contains a topping and that is removably attached to a ceiling mount hub on the top of the housing;
a valve housing attached to a bottom end of the topping container; and
a delivery tube configured to deliver a controlled portion of the topping downward and out of a bottom of end of the delivery tube.

20. The vending machine of claim 16 further comprising:
a product delivery assembly located at a front side of the housing for receiving the customer treat for the first user; and
a door in the product delivery assembly configured to be opened and closed by the robot.
